(19) United States
(12) Patent Application Publication
(10) Pub. No.: US 2009/0305559 A1
(43) Pub. Date: Dec. 10, 2009

(54) RF CONNECTOR HAVING IMPROVED COLLAR

(75) Inventors: Xiao-Guo Zhang, Kunshan (CN); Qing-Man Zhu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/477,928

(22) Filed: Jun. 4, 2009

(30) Foreign Application Priority Data
Jun. 4, 2008 (CN) 200820037219.9

(51) Int. Cl. H01R 9/05

(52) U.S. Cl. 439/578

(57) ABSTRACT

The RF connector (100) has a collar (11) defining an axial bore (110), an insulator (12) mounted into the axial bore and having an axial hole (121) defining therethrough, a central pin (13) retained in the axial hole of the insulator and an outer shield (10) partially enclosing a front portion of the axial bore. The outer shield has a protruding portion (103) extending forwardly to form an interior room (101) for receiving the mating connector. The collar has a claw (111) extending therearound to flexibly resist against an inner surface of the mating connector.

### BACKGROUND OF THE INVENTION

1. Field of the Invention

The present invention relates to a RF (Radio Frequency) connector, and more particularly to a RF connector having an improved collar for engaging with a mating connector.

2. Description of the Prior Art

U.S. Pat. No. 6,848,931 issued to MeMullen et al. on Feb. 1, 2005 discloses an RF connector for transmitting RF signal and engaging with a mating connector. The RF connector has a first main body defining a hollow, an insulative member received in the hollow, a center conductor retained within the insulative member, an outer shield enclosing the first main body, and a tubular enclosing the outer shield. The tubular defines an interior room for receiving the mating connector and has a hook portion extending into the interior room for locking with the mating connector. However, the tubular described above would result in a great complexity process and a high cost during assembly the tubular to the first main body.

Hence, an improved RF connector is needed to solve the above problem.

### BRIEF SUMMARY OF THE INVENTION

Object of the present invention is to provide a RF connector for easing the assembling of the RF connector.

The present invention provides a RF (Radio Frequency) connector for engaging with a mating connector. The RF connector has a collar defining an axial bore, an insulator mounted into the axial bore and having an axial hole defined therethrough, a central pin retained in the axial hole of the insulator and an outer shield partially enclosing a front portion of the axial bore. The outer shield has a protruding portion extending forwardly to form an interior room for receiving the mating connector. The collar has a claw extending therearound to flexibly resist against an inner surface of the mating connector.

It is easily to assemble the RF connector in order that the claw extends from the collar to abutting against the mating connector.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is a perspective view of a RF connector and a mating connector in accordance with a first embodiment;

FIG. 2 is an exploded view of the RF connector as shown in FIG. 1;

FIG. 3 is a cross-sectional view of the RF connector when the mating connector is not inserted into an interior room of the RF connector;

FIG. 4 is a cross-sectional view of the RF connector as shown in FIG. 1, when the second connector is inserted into an interior room of the RF connector; and

FIG. 5 is a cross-sectional view of the RF connector in accordance with a second embodiment, when the mating connector is inserted into an interior room of the RF connector.

### DETAILED DESCRIPTION OF THE INVENTION

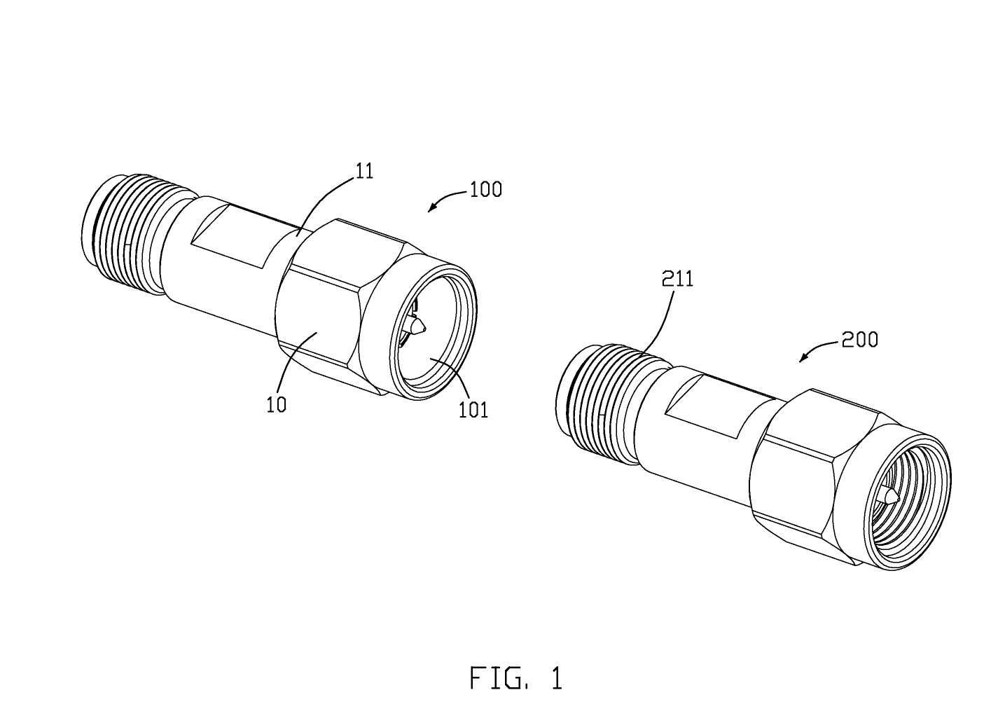

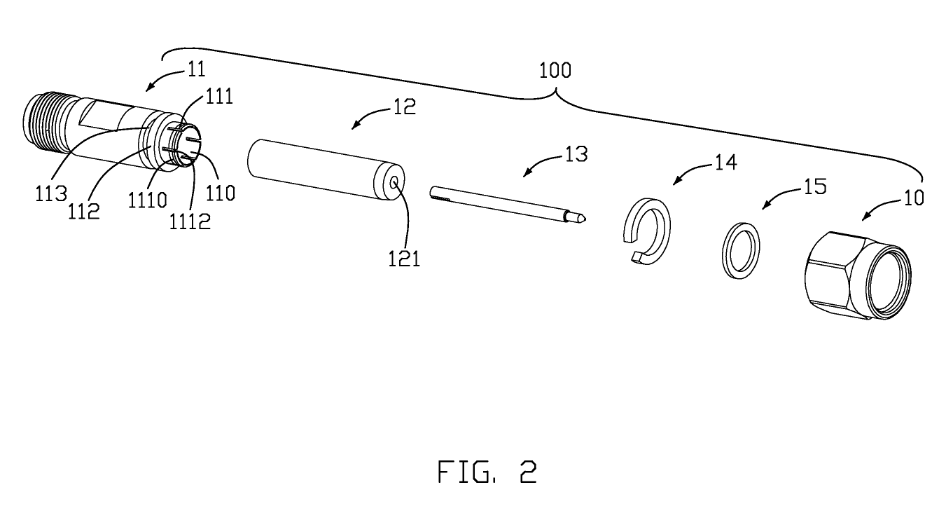

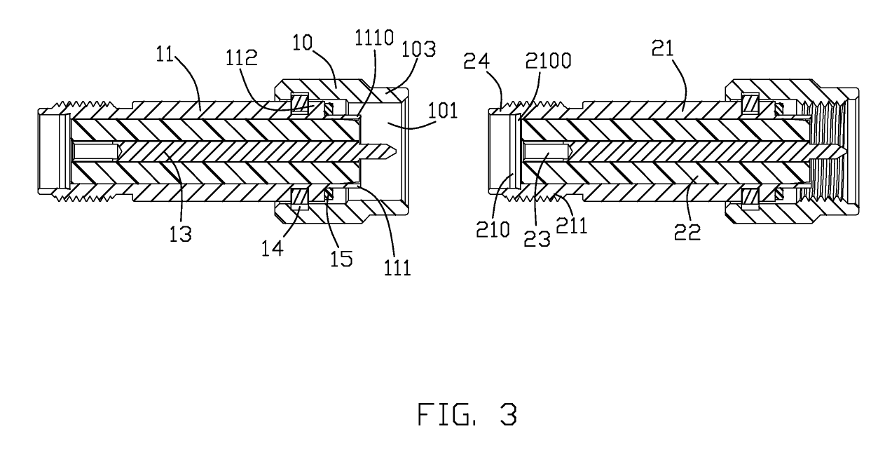

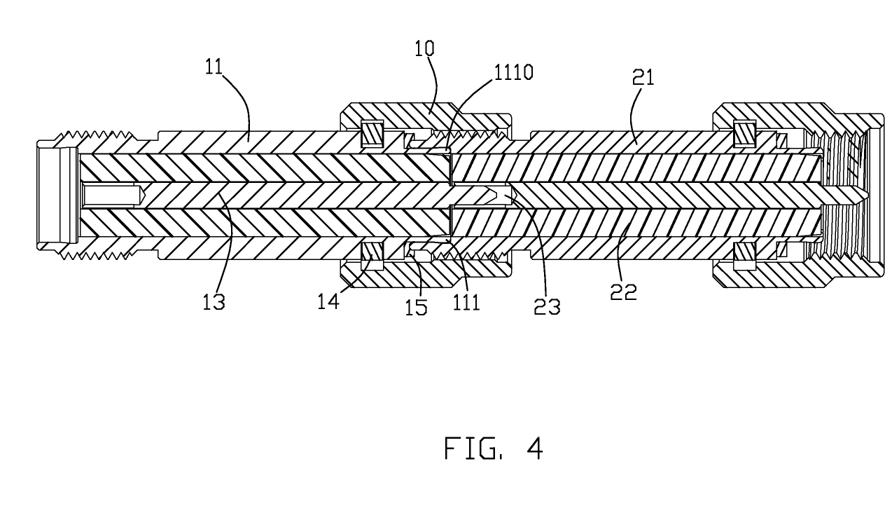

Reference will now be made to the drawing figures to describe a first embodiment of the present invention in detail. Referring to FIGS. 1-4, a RF connector 100 for engaging with a mating connector 200 comprises a collar 11 defining an axial bore 110, an insulator 12 mounted into the axial bore 110 and having an axial hole 121 defined therethrough, a central pin 13 retained in the axial hole 121 of the insulator 12, and an outer shield 10 partially enclosing a front portion of the collar 11. The outer shield 10 has a protruding portion 103 extending forwardly to form an interior room 101 for receiving the mating connector 200. The collar 11 has an edge portion 112. The collar 11 comprises a claw 111 extending from the edge portion 112 to flexibly resist against an inner surface of the mating connector 200. A diameter of the claw 111 is smaller than a diameter of the edge portion 112. The claw 111 has a flange portion 1110 protruding from an outside face thereof for abutting against the inner surface of the mating connector 200. The claw 111 comprises a plurality of splits 1112 to divide the claw 111 into small claw portions for sufficiently and flexibility resisting against the mating connector 200.

The collar 11 has an annular recess 113 defined on the outer surface thereof. The RF connector 100 further comprises a ring 14 retained in the recess 113 and partially protruding from the recess 113 for locking with the outer shield 10. The RF connector 100 has a flexible bushing 15 enclosing the claw 111 and resisting against the edge portion 112 of the collar 11. The flexible bushing 15 is sandwiched between the RF connector 100 and the mating connector 200.

The mating connector 200 comprises a main body 21 defining an axial bore (not labeled), an insulative member 22 received in the axial bore, a central terminal 23 disposed in the insulative member 22 for electrically connecting with the central pin 13 of the RF connector 100. The mating connector 200 comprises a pluggable portion 24 extending from the main body 21 and forming a receiving space 210 for retaining the claw 111 of the RF connector 100. The pluggable portion 24 has an annular hollow 2100 defined on the inner surface thereof. The claw 111 of the RF connector 11 is received into the receiving space 210 of the mating connector 200. The flange portion 1110 of the claw 111 mates with the annular hollow 2100 of the mating connector 200 and flexibly resists against the inner surface of the hollow 2100. The main body 21 has a plurality of whirls 211 disposed on the outside thereof.

When the mating connector 200 is plugged into the interior room 101 of the RF connector 100, a pluggable portion 24 of the mating connector 200 is received in the interior room 101. The claw 111 is retained in the receiving space 210 of the pluggable portion 24. The flange portion 1110 of the claw 111 mates with the annular hollow 2100 of the mating connector 200 and firmly flexibly resists against the inner surface of the hollow 2100.

The collar 11 and the claw 11 are made as a whole. The claw 111 extends from the collar 11 for abutting against the mating connector 200 so as to ease the assembling of the RF connector 100.

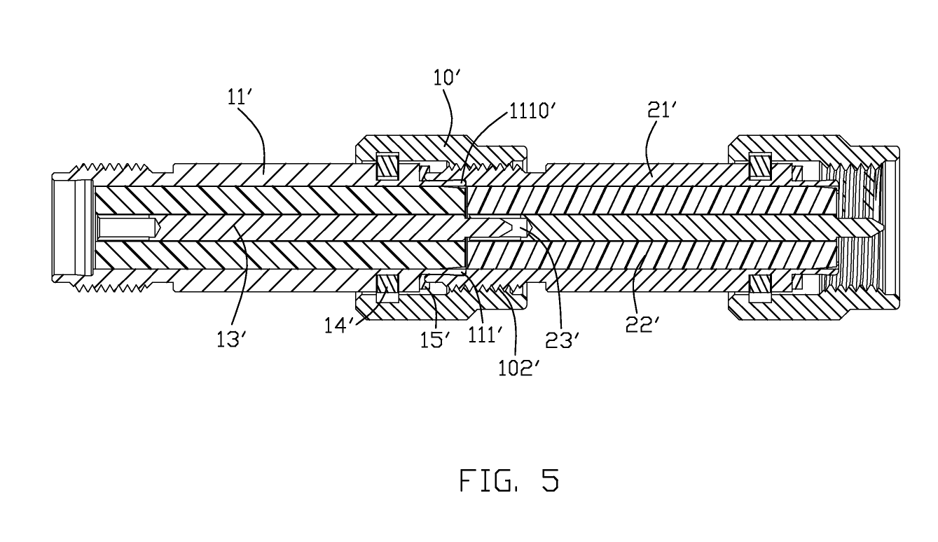

Referring to FIG. 5, it refers a second embodiment of the RF connector 100′, the RF connector 100′ has a collar 11′, an outer shield enclosing the collar, a central pins 13′ for connecting with a terminal 23 of the mating connector. The RF connector 100′ has a plurality of threads 102′ disposed on an inner surface of the outer shield 10′. The mating connector has a main body 21 and an insulative member 22′. The mating connector screws into the interior room (not labeled) of the RF connector 100′, and the flange portion 1110′ of the claw 111′ mates with the annular hollow (not labeled) of the mating connector 200′.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A RF (Radio Frequency) connector for engaging with a mating connector, said RF connector comprising:
a collar defining an axial bore and comprising a claw extending therearound to flexibly resist against an inner surface of the mating connector;
an insulator mounted into the collar and having an axial hole defined therethrough;
a central pin retained in the axial hole of the insulator; and
an outer shield partially enclosing a front portion of the collar and having a protruding portion extending forwardly to form an interior room for receiving the mating connector.

2. The RF connector as claimed in claim 1, wherein said claw has a flange portion protruding from an outside face thereof for abutting against the inner surface of the mating connector.

3. The RF connector as claimed in claim 1, wherein said claw comprises a plurality of splits for dividing the claw into small claw portions.

4. The RF connector as claimed in claim 1, wherein said collar has an annular recess defined on the outer surface thereof, and wherein the RF connector further comprises a ring retained in the recess and partially protruding from the recess for locking with the outer shield.

5. The RF connector as claimed in claim 1, wherein said collar has an edge portion, and wherein said claw extends from the edge portion, a diameter of the claw being smaller than a diameter of the edge portion.

6. The RF connector as claimed in claim 5, further comprising a flexible bushing enclosing the claw and resisting against the edge portion of the claw, the flexible bushing being sandwiched between the RF connector and the mating connector.

7. A RF connector assembly, comprising:
a RF connector, comprising:
a collar defining an axial bore and comprising a claw extending forwardly;
an insulator mounted into the collar and having an axial hole defined therethrough;
a central pin retained in the axial hole of the insulator;
an outer shield partially enclosing a front portion of the axial bore and having a protruding portion extending forwardly to form an interior room for receiving the mating connector; and
a mating connector, comprising:
a main body defining an axial bore and comprising a pluggable portion extending therefrom and forming a receiving space for retaining the claw of the RF connector, the claw resisting against an inner surface of the pluggable potion.
an insulative member received in the axial bore; and
a central terminal disposed in the insulative member for electrically connecting with the central pin of the RF connector.

8. The RF connector assembly as claimed in claim 7, wherein said claw of the RF connector has a flange portion protruding from an outside face thereof for abutting against the inner surface of the mating connector.

9. The RF connector assembly as claimed in claim 8, wherein said pluggable portion of the mating portion has an annular hollow defined around of the inner surface for mating with the flange portion of the claw.

10. The RF connector assembly as claimed in claim 7, wherein said claw comprises a plurality of splits for dividing the claw into small claw portions.

11. An RF connector assembly comprising:
a first connector including:
an insulator enclosing a first center pin;
a metallic collar enclosing said first housing and including an inwardly deflectable/shrinkable claw at a front end thereof;
a metallic outer shield attached to and enclosing a front portion of the collar; and
a second connector including:
an insulative member enclosing a second center pin;
a metallic main body enclosing the insulative member and including, at a rear end thereof, a pluggable portion defining an interior receiving space to receive the claw therein, and a thread portion formed on an exterior face of a rear portion of the main body; wherein
the receiving space and the claw are configured to generate an engagement not only radially but also axially so as to retain the first connector and the second connector to be mated together.

12. The RF connector assembly as claimed in claim 11, wherein said claw defines a flange portion at a front end thereof, and the pluggable portion further defines a hollow in said receiving space to accommodate said flange portion so as to generate said engagement between the claw and the pluggable portion axially.

13. The RF connector assembly as claimed in claim 11, wherein said claw defines a plurality of splits to form a plurality of small claw portions.

14. The RF connector assembly as claimed in claim 11, wherein said outer shield encloses the rear portion of the main body.

15. The RF connector assembly as claimed in claim 11, wherein said outer shield is equipped with or without threads on an interior surface thereof.

16. The RF connector assembly as claimed in claim 11 wherein said first connector and said second connector are similar to each other under condition that the first center pin is same as the second center pin, the insulator is same as the insulative member, the collar is same as the main body, and the second connector is also equipped with another outer shield except that one of said outer shields is equipped with threads on an inner surface while the other not.
